(19) United States
(12) Patent Application Publication
(10) Pub. No.: US 2025/0368275 A1
(43) Pub. Date: Dec. 4, 2025

(54) VEHICLE SILL PLATE SECURING SYSTEMS AND ASSOCIATED METHODS

(71) Applicant: Alutrim North America, Lebanon, KY (US)

(72) Inventor: John Kevin Gootee, JR., Lebanon, KY (US)

(73) Assignee: Alutrim North America, Lebanon, KY (US)

(21) Appl. No.: 18/676,725

(22) Filed: May 29, 2024

(51) Int. Cl. B62D 25/20

(52) U.S. Cl. CPC B62D 25/2036

(57) ABSTRACT

A vehicle sill plate includes a plate body having a first face and a second face that is opposite the first face. The plate body is sized to be received within a recess that is elongated in a vehicle longitudinal direction of an inner door frame sill member configured to form part of a door sill frame of a vehicle. A plurality of tabs that extend outward from the plate body. Each tab includes a base that is connected to the plate body and a head that extends outward from the base in a widthwise direction of the tab thereby extending over the plate body. The tab is shaped and configured to be received within a slot formed in the door frame sill member to connect the plate body to the door frame sill member.

### TECHNICAL FIELD

The present specification generally relates to vehicle trim securing systems and, more specifically, to vehicle sill plate securing systems and methods for vehicles.

### BACKGROUND

Vehicles include various side trim pieces around door frames. One such trim piece is a door sill trim piece. Some door sill trim pieces may have a sill plate that is part of the door sill. The sill plate may be connected to the assembly to secure the assembly together.

Accordingly, a need exists for vehicle sill plate securing systems and associated methods.

### SUMMARY

In one embodiment, a vehicle sill plate includes a plate body having a first face and a second face that is opposite the first face. The plate body is sized to be received within a recess that is elongated in a vehicle longitudinal direction of an inner door frame sill member configured to form part of a door sill frame of a vehicle. A plurality of tabs that extend outward from the plate body. Each tab includes a base that is connected to the plate body and a head that extends outward from the base in a widthwise direction of the tab thereby extending over the plate body. Each tab is shaped and configured to be received within a slot formed in the door frame sill member to connect the plate body to the door frame sill member.

In another embodiment, a vehicle sill assembly includes an inner door frame sill member configured to form part of a door sill frame of a vehicle. A vehicle sill plate includes a plate body having a first face and a second face that is opposite the first face. The plate body is received within a recess that is elongated in a vehicle longitudinal direction of the inner door frame sill member that forms part of a door sill frame of a vehicle. A plurality of tabs extend outward from the plate body. Each tab includes a base that is connected to the plate body and a head that extends outward from the base in a widthwise direction of the tab thereby extending over the plate body. Each tab is received within a corresponding slot formed in the door frame sill member connecting the plate body to the door frame sill member within the recess.

In another embodiment, a method of forming a vehicle sill plate is provided. The method includes forming a plate body having a first face and a second face that is opposite the first face. The plate body, once formed, is configured to be received within a recess that is elongated in a vehicle longitudinal direction of an inner door frame sill member that forms part of a door sill frame of a vehicle. A plurality of tabs are formed that extend outward from the plate body. Each tab includes a base that is connected to the second face and a head that extends outward from the base in a widthwise direction of the tab thereby extending over the plate body. Each tab being shaped and configured to be received within a slot formed in the door frame sill member to connect the plate body to the door frame sill member.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a portion of an interior of a vehicle including a sill assembly, according to one or more embodiments shown and described herein;

FIG. 2 schematically depicts a portion of a sill plate including tabs for connecting to a door frame sill member, according to one or more embodiments shown and described herein;

FIG. 3 schematically depicts a side view of the sill plate including tab inserted within a slot of the door frame sill member of FIG. 2, according to one or more embodiments shown and described herein;

FIG. 4 schematically depicts a bottom view of a portion of the sill assembly of FIG. 1, according to one or more embodiments shown and described herein; and

FIG. 5 diagrammatically illustrates a method of forming the sill plate of FIG. 1, according to one or more embodiments shown and described herein.

### DETAILED DESCRIPTION

Vehicles according to the present specification include a vehicle sill plate securing system that includes a vehicle sill plate including a plate body that has a first face and a second face that is opposite the first face. The plate body is sized to be received within a recess that is elongated in a vehicle longitudinal direction of an inner door frame sill member configured to form part of a door sill frame of a vehicle. A plurality of tabs extend outward from the plate body. Each tab includes a base that is connected to the plate body and a head that extends outward from the base in a widthwise direction of the tab thereby extending over the plate body. The tab is shaped and configured to be received within a slot formed in the door frame sill member to connect the plate body to the door frame sill member.

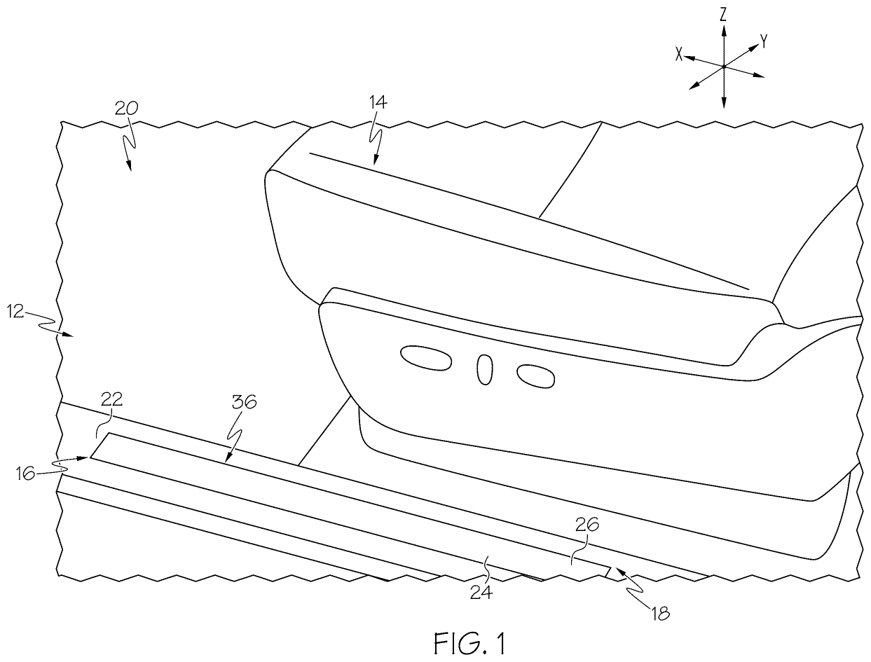

As used herein, the term “vehicle longitudinal direction” refers to the forward-rearward direction of the vehicle (i.e., in the +/−vehicle Y direction depicted in FIG. 1). The term “vehicle lateral direction” refers to the cross-vehicle direction (i.e., in the +/−vehicle X direction depicted in FIG. 1), and is transverse to the vehicle longitudinal direction. The term “vehicle vertical direction” refers to the upward-downward direction of the vehicle (i.e., in the +/−vehicle Z-direction depicted in FIG. 1). As used herein, “upper” and “above” are defined as the positive Z direction of the coordinate axis shown in the drawings. “Lower” and “below” are defined as the negative Z direction of the coordinate axis shown in the drawings.

Referring to FIG. 1, a partial perspective view of a vehicle floor assembly 12 that is part of a passenger compartment 14 of a vehicle 10 is shown. The vehicle 10 includes a door frame, generally indicated as element 16, that includes a door sill frame 18 that is located at an entrance to an interior 20 of the vehicle 10, in this case, the driver side, but any of the doors may include the same or a similar door sill frame. The door sill frame 18 includes a door frame sill member 22, which is a trim panel that is located at the door sill frame 18 near floor 23. Connected to the door frame sill member 22 is a vehicle sill plate 24. The vehicle sill plate 24 may be elongated in shape in the vehicle longitudinal direction and be formed of a material (e.g., aluminum or other metal) that is different than material forming the door frame sill member 22 (e.g., plastic). The vehicle sill plate 24 may include raised ribs 26 that are spaced-apart in the vehicle lateral direction that can help to provide traction for entering the interior 20 of the vehicle 10.

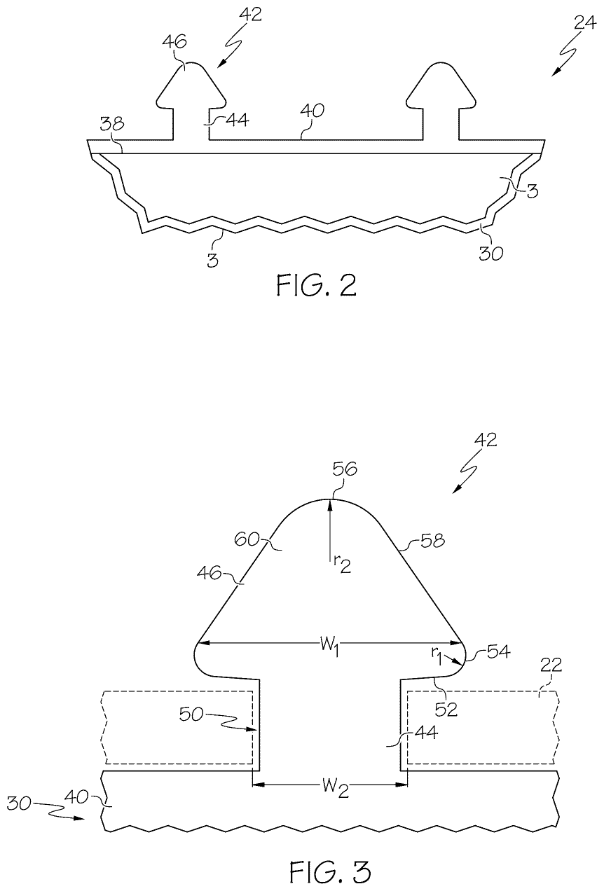

Referring to FIG. 2, a portion of the vehicle sill plate 24 is shown and includes a plate body 30 having a first face 32 and a second face 34 that is opposite the first face 32. The plate body 30 sized to be received within a recess 36 (FIG. 1) that is elongated in the vehicle longitudinal direction and has the same shape as the vehicle sill plate 24. Each outer edge 38 of the plate body 30 may have a longitudinally extending flange 40 that extends transverse to the first and second faces 32 and 34. In other embodiments, only one or none of the outer edges 38 may have a flange. In the illustrated embodiment, A plurality of tabs 42 extend outward from the plate body 30 at the flanges 40. As will be described in greater detail below, the tabs 42 can be used to connect the vehicle sill plate 24 to the door frame sill member 22 and within the recess 36.

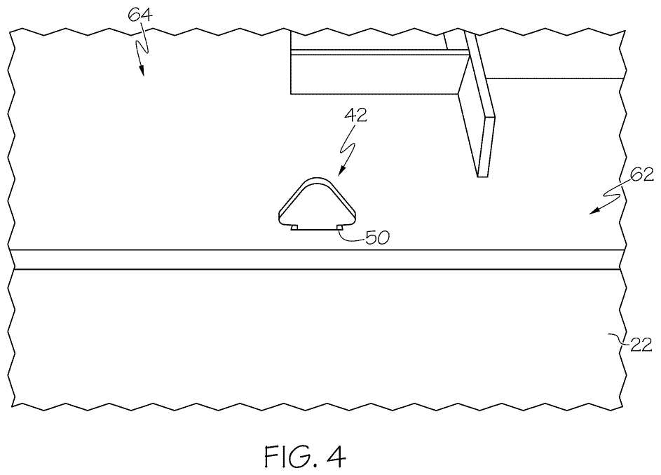

Referring to FIG. 3, each tab 42 includes a base 44 that is connected to the plate body 30 and a head 46 that extends outward from the base in a widthwise direction W₁ of the tab 42. In this regard, the head 46 is considered to be overhanging or extending over the plate body 30. The tab 42 is shaped and configured to be received within a slot 50 formed in the door frame sill member 22 to connect the plate body 30 to the door frame sill member 22. In particular, the head 46 of each tab 42 extends outward from the base 44 at an overhang portion 52 that overhangs the second face 34 to a curve 54 and then to a taper portion 58 that tapers from the curve 54 to an apex 56. The curve 54 has a first radius of curvature r₁ that is less than a second radius of curvature r₂ of the apex 56.

In this embodiment, the tabs 42 are formed as an integral, monolithic structure along with the plate body 30. For example, the tabs 42 can be formed during a stamping process where the tabs 42 are cut and the edges 38 are bent from a sheet of aluminum or other suitable metal. Because the tabs 42 are formed from a sheet, each tab 42 has a plate-like body 60 forming the base 44 and the head 46.

Referring to FIG. 4, a vehicle sill assembly 62 includes the door frame sill member 22 shown from a bottom (i.e., hidden) face 64 and the vehicle sill plate 24, which only the tabs 42 can be seen. Each tab 42 is received within a corresponding slot 50 formed in the door frame sill member 22. Referring also to FIG. 3, a width W₂ of the slot 50 may be less than the width W₁ of the head 46 at the overhang portions 52 that overhang the second face 34.

thereby connecting the plate body 30 to the door frame sill member 22. The head 46 includes the tapered portions 58 (FIG. 3), which reduce the width of the head 46, which can facilitate pushing the tabs 42 through the slots 50.

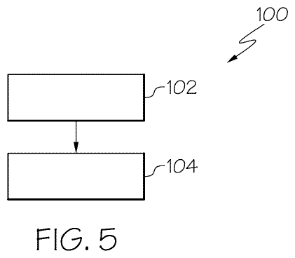

Referring to FIG. 5, a method 100 of forming the vehicle sill plate 24 includes forming the plate body 30 having the first face 32 and the second face 34 that is opposite the first face 32 at step 102. The plate body 30, once formed, is configured to be received within the recess 36 that is elongated in the vehicle longitudinal direction of the inner door frame sill member 22 that forms part of the door sill frame 18 of the vehicle 10 (FIG. 1). At step 104, the plurality of tabs 42 are formed that extend outward from the plate body 30, each tab includes the base 44 that is connected to the second face 34 and the head 46 that extends outward from the base 44 in the widthwise direction of the tab thereby extending over the plate body 30. The tab 42 is shaped and configured to be received within the corresponding slot 66 formed in the door frame sill member 22 to connect the plate body 30 to the door frame sill member 22. In some embodiments, steps 102 and 104 are formed simultaneously or may be formed separately, for example, using different processes.

The above-described vehicle sill plate securing systems include a sill plate with a sill plate body with multiple tabs that can be inserted within respective recesses in a door frame sill member. The tabs have enlarged heads to grab onto the door frame sill member to provide an interference fit therebetween. This interference fit can eliminate a need to crimp tabs around the door frame sill member.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle sill plate comprising:
a plate body having a first face and a second face that is opposite the first face, the plate body sized to be received within a recess that is elongated in a vehicle longitudinal direction of an inner door frame sill member configured to form part of a door sill frame of a vehicle; and
a plurality of tabs that extend outward from the plate body, each tab comprising a base that is connected to the plate body and a head that extends outward from the base in a widthwise direction of the tab thereby extending over the plate body, each tab being shaped and configured to be received within a slot formed in the door frame sill member to connect the plate body to the door frame sill member.

2. The vehicle sill plate of claim 1, wherein the head of each tab tapers in the widthwise direction of the tab from the base to an apex.

3. The vehicle sill plate of claim 1, wherein the head of each tab extends outward from the base at an overhang portion that overhangs the second face to a curve and then to a taper portion that tapers from the curve to the apex, the curve having a first radius of curvature that is less than a second radius of curvature of the apex.

4. The vehicle sill plate of claim 1, wherein the plurality of tabs are formed of a same material as the plate body.

5. The vehicle sill plate of claim 4, wherein the material is aluminum.

6. The vehicle sill plate of claim 4, wherein each tab includes a plate-like tab body forming the base and the head.

7. A vehicle sill assembly comprising:
an inner door frame sill member configured to form part of a door sill frame of a vehicle; and
a vehicle sill plate comprising:
a plate body having a first face and a second face that is opposite the first face, the plate body received within a recess that is elongated in a vehicle longitudinal direction of the inner door frame sill member that forms part of a door sill frame of a vehicle; and
a plurality of tabs that extend outward from the plate body, each tab comprising a base that is connected to the plate body and a head that extends outward from the base in a widthwise direction of the tab thereby extending over the plate body, each tab is received within a corresponding slot formed in the door frame sill member connecting the plate body to the door frame sill member within the recess.

8. The vehicle sill assembly of claim 7, wherein the head of each tab tapers in the widthwise direction of the tab from the base to an apex.

9. The vehicle sill assembly of claim 7, wherein the head of each tab extends outward from the base at an overhang portion that overhangs the second face to a curve and then to a taper portion that tapers from the curve to the apex, the curve having a first radius of curvature that is less than a second radius of curvature of the apex.

10. The vehicle sill assembly of claim 7, wherein the plurality of tabs are formed of a same material as the plate body.

11. The vehicle sill assembly of claim 10, wherein the material is aluminum.

12. The vehicle sill assembly of claim 10, wherein each tab includes a plate-like tab body forming the base and the head.

13. A method of forming a vehicle sill plate, the method comprising:
(a) forming a plate body having a first face and a second face that is opposite the first face, the plate body, once formed, configured to be received within a recess that is elongated in a vehicle longitudinal direction of an inner door frame sill member that forms part of a door sill frame of a vehicle; and
(b) forming a plurality of tabs that extend outward from the plate body, each tab comprising a base that is connected to the second face and a head that extends outward from the base in a widthwise direction of the tab thereby extending over the plate body, each tab being shaped and configured to be received within a slot formed in the door frame sill member to connect the plate body to the door frame sill member.

14. The method of claim 13, wherein steps (a) and (b) are performed simultaneously.

15. The method of claim 13, wherein steps (a) and (b) are performed separately.

16. The method of claim 13, wherein the head of each tab is formed tapering in the widthwise direction of the tab from the base to an apex.

17. The method of claim 13, wherein the head of each tab is formed extending outward from the base at an overhang portion that overhangs the second face to a curve and then to a taper portion that tapers from the curve to the apex, the curve having a first radius of curvature that is less than a second radius of curvature of the apex.

18. The method of claim 13, wherein the plurality of tabs are formed of a same material as the plate body.

19. The method of claim 18, wherein the material is aluminum.

20. The method of claim 18, wherein each tab is formed including a plate-like tab body forming the base and the head.
